(19) United States
(12) Patent Application Publication
(10) Pub. No.: US 2011/0173587 A1
(43) Pub. Date: Jul. 14, 2011

(54) METHOD AND SYSTEM FOR GAME DEVELOPMENT FOR MOBILE DEVICES

(75) Inventor: Dennis DETWILLER, Vancouver (CA)

(73) Assignee: ALIEN TOOL KIT SOFTWARE INC., Vancouver (CA)

(21) Appl. No.: 12/685,670

(22) Filed: Jan. 11, 2010

(51) Int. Cl. G06F 9/44; G06F 9/445

(52) U.S. Cl. 717/109; 717/174

(57) ABSTRACT

A custom application is for managing a library of games on a hand held mobile processing device. The custom application comprises: a link to a collection of formatted games on the hand held mobile processing device which constitute the library of games, each of the formatted games comprising coding understandable by the handheld mobile processing device to deploy at least one of the games; and an import/export module for trading at least one of the formatted games with multiple computers or other hand held mobile processing devices.

### CROSS-REFERENCE TO RELATED APPLICATIONS

This is the first application filed with regards to the present description.

### TECHNICAL FIELD

The present disclosure relates to computer game development tools and more particularly to programming-free game development tools for use with mobile devices.

### BACKGROUND

Computer game developing typically requires a coder, a designer and an artist along with tens of thousands of dollars of overhead, not to mention weeks or months of testing. While some existing applications are capable of assisting non-professional designer users in creating computer games, such applications generally require some kind of basic coding knowledge. In addition, such applications are generally not suitable for directly deploying the games on handheld mobile processing platforms, such as smart phones.

There is thus a need for an improved game development tool which addresses issues associated with the prior art.

### SUMMARY

Prior art shortcomings such as those enumerated in the above section are herein addressed to provide a game development tool capable of deploying games onto mobile devices.

In accordance with an embodiment, there is herein provided a custom application for managing a library of games on a hand held mobile processing device, the custom application comprising: a link to a collection of formatted games on the hand held mobile processing device which constitute the library of games, each of the formatted games comprising coding understandable by the handheld mobile processing device to deploy at least one of the games; and an import/export module for trading at least one of the formatted games with multiple computers or other hand held mobile processing devices.

In accordance with an embodiment, there is herein provided a method for managing a library of games on a hand held mobile processing device using a custom application, the method comprising: collecting formatted games on the hand held mobile processing device to create the library of games, each of the formatted games comprising coding understandable by the handheld mobile processing device to deploy at least one of the games; and trading at least one of the formatted games with multiple computers or other hand held mobile processing devices.

In accordance with an embodiment, there is herein provided a method of creating a game to be deployed on a handheld mobile processing device, the method comprising: displaying a visual, programming-free computer environment allowing a user to establish a game level, an instance of a game element, and a game rule applicable to at least one of the instance and the game level; creating a game file comprising the game element, the instance of the game element, the game level, and the game rule; generating a game prototype from the game file; displaying the game prototype in the computer environment to provide a mock-up of the game as to be seen when the game is to be played, with the game level and the instance of the game element in accordance with the game rule; and formatting the game prototype into a formatted game comprising coding understandable by the handheld mobile processing device to deploy the game.

In accordance with an embodiment, the method further comprises exporting the formatted game to the handheld mobile processing device.

In accordance with an embodiment, the method further comprises deploying the formatted game on the handheld mobile processing device using the coding.

In accordance with an embodiment, the method further comprises displaying the game for playing on the handheld mobile processing device.

In accordance with an embodiment, the method further comprises using a custom application on the hand held mobile processing device for at least one of: collecting more than one formatted game on the hand held mobile processing device or on multiple computers; displaying the formatted game on the hand held mobile processing device or on multiple computers; and trading the formatted game with multiple computers or other hand held mobile processing devices.

In accordance with an embodiment, the method further comprises exporting the formatted game to a processing device; and, in the processing device, further editing the game.

In accordance with an embodiment, the formatting the game prototype into the formatted game of the method comprises: formatting the game prototype into an Xcode file; and exporting the Xcode file to an Xcode development tool associated with the handheld mobile processing device, for further editing of the game.

In accordance with an embodiment, the method further comprises receiving a game editing command provided by the user interacting with the computer environment; and updating the game file in accordance with the game editing command.

In accordance with an embodiment, the displaying the game prototype in the computer environment of the method comprises displaying the game element in accordance with a hand-drawn-like appearance.

In accordance with an embodiment, the displaying the game prototype in the computer environment of the method comprises displaying the game level with a graphical paper-like background.

In accordance with an embodiment, the displaying the visual, programming-free computer environment of the method comprises displaying game element icons corresponding to multiple available game elements; and receiving the instance of the game element upon the user dragging and dropping one of the game element icons into the game level.

In accordance with an embodiment, the displaying the visual, programming-free computer environment of the method comprises displaying game element types in a game element menu; receiving a type of the game element upon the user selecting one of the game element types in the game element menu; and creating the game element in accordance with the type selected.

In accordance with an embodiment, the game element types of the method comprise at least one of: an active game element; a passive game element; an action trigger of the game level.

In accordance with an embodiment, the displaying the visual, programming-free computer environment of the method comprises displaying available game rules in a game rule menu; receiving a user selection of one of the available game rules; and creating the game rule in accordance with the user selection.

In accordance with an embodiment, the method further comprises the displaying the available game rules of the method comprises displaying a description of at least one of the available game rules to facilitate the user selection.

In accordance with an embodiment, the displaying the visual, programming-free computer environment of the method comprises displaying a game level menu to allow the user to at least one of: create and select the game level.

In accordance with an embodiment, the displaying the visual, programming-free computer environment of the method comprises displaying a list of available collision types, each one of the available collision types for defining a space in the game level where a particular collision rule is to be applied in the game.

In accordance with an embodiment, the displaying the environment of the method comprises displaying a prompt for at least one of: creating a new game file; and opening an existing, previously created game file.

In accordance with an embodiment, the method further comprises storing the game element in a game warehouse database accessible via a communication network.

In accordance with an embodiment, the method further comprises retrieving available game elements from a game warehouse database accessible via a communication network; and displaying the available game elements to the user.

In accordance with an embodiment, the method further comprises importing at least one of an image data file and a sound data file; and associating the at least one of the image data file and the sound data file to at least one of the game level and the game element; wherein the generating the game file comprises generating the game file based on the at least one of the image data file and the sound data file.

In accordance with an embodiment, there is herein provided a system for creating a game to be deployed on a handheld mobile processing device, the system comprising: a graphical user interface for displaying an visual, programming-free computer environment allowing a user to establish a game level, an instance of a game element, and a game rule applicable to at least one of the instance and the game level, via visual interaction with the computer environment a processing device in operative communication with the graphical user interface; and a memory device operatively coupled to the processing device, the memory device comprising instructions for implementing the processing device to: create a game file comprising the game element, the instance of the game element, the game level, and the game rule; generate a game prototype from the game file; display the game prototype in the computer environment to provide a mock-up of the game as to be seen when the game is to be played, with the game level and the instance of the game element in accordance with the game rule; format the game prototype into a formatted game comprising coding understandable by the handheld mobile processing device; and display the game on the handheld mobile processing device as provided by the coding of the formatted game, to allow the game to be deployed and played on the handheld mobile processing device.

In accordance with an embodiment, the system further comprises an export module for exporting the formatted game to at least one of the handheld mobile processing device, and an other processing device adapted to further edit the game.

In accordance with an embodiment, the export module of the system is adapted to output an Xcode file from the game prototype, to an Xcode development tool associated with the handheld mobile processing device.

In accordance with an embodiment, the memory device of the system comprises instructions for implementing the processing device to receive a game editing command from the graphical user interface upon the user interacting with the computer environment; and updating the game file in accordance with the game editing command.

In accordance with an embodiment, there is herein provided a user interface for allowing a user to create a game to be deployed on a handheld mobile processing device, the user interface comprising: a visual, programming-free environment comprising: a game level menu allowing the user to define a game level; a game element menu allowing the user to define an instance of a game element; a game rule menu allowing the user to define a game rule applicable to at least one of the instance and the game level; and a game mock-up display for displaying a mock-up of the game as to be seen when the game is to be played on the handheld mobile processing device, with the game level and the instance of the game element being displayed in accordance with the game rule; and an export icon allowing the user to initiate an exporting of the game into a coding format allowing the game to be played on the handheld mobile processing device.

In accordance with an embodiment, there is herein provided a computer readable medium storing instructions for implementing a processing device to create a game to be deployed on a handheld mobile processing device, the instructions comprising: displaying an visual, programming-free computer environment on a display device, the computer environment allowing a user to establish a game level, an instance of a game element, and a game rule applicable to at least one of the instance and the game level, via visual interaction with the computer environment; creating a game file comprising the game element, the instance of the game element, the game level, and the game rule; generating a game prototype from the game file; displaying the game prototype on the display device, in the computer environment, to provide a mock-up of the game as to be seen when the game is to be played, with the game level and the instance of the game element in accordance with the game rule; formatting the game prototype into a formatted game comprising coding understandable by the handheld mobile processing device; and displaying the game on the handheld mobile processing device as provided by the coding of the formatted game, to allow the game to be deployed and played thereon.

In the present description, the term “game” is intended to refer to a playable, interactive visual and displayable environment as per any computer game. The term “game” encompasses a finished product ready to be published for mass usage by the general public for example, as well as a game which will eventually integrate more content and/or be edited in some way prior to being ready for publication. The term “game prototype” refers to a game designed using the herein described tool and method, prior to being formatted for usage on a mobile device for example.

In the present description, the term “game element” is intended to refer to game content including actors, props and triggers.

The term “game level” is intended to refer to the “ground”, or the gaming environment, on which the game elements “play”.

The term “actor” is intended to refer to an active game element such as a game character which acts or has the capability to move in a game. Each “actor” has an assigned visual shape and is defined by parameters.

The term “prop” is intended to refer to is a passive game element which holds still in the game. Props can be handled by actors, and include items such as weapons or gems for example. Props are defined in terms of parameters which may relate to actor-like qualities.

The term “game rule” is intended to refer to any parameter which defines how the game is to proceed upon certain events happening in the game. A “game rule” can be defined as being a parameter of any type of game element or game level. Triggers are considered as defining a game rule.

The term “trigger” is intended to refer to something that, when activated, causes the game to change in some way. For example, a trigger (or action trigger) may be associated to a game level or a prop, but generally remains independent of actors.

The term “instance” refers to a game element which has specifically defined parameters associated to it. Several instances of a single game element are possible and possess certain characteristics in common, but their specific parameters are different. For example, an actor is represented by a given shape. A first instance of this actor is the player of the game, while another instance of this same actor represents an enemy. In this example, the enemy and the player have the same shape, although not necessarily the same colour; they are instances of the actor, each having different player and enemy parameters.

### BRIEF DESCRIPTION OF THE DRAWINGS

Further features and advantages of the invention will become apparent from the following present detailed description, taken in combination with the appended drawings, in which:

FIG. 1 is a schematic illustration of a system for creating a game in accordance with an embodiment, the system being implemented on a mobile device;

FIG. 2 is a schematic illustration of the system of FIG. 1, further adapted to export to a mobile device and a game development tool, in accordance with an embodiment;

FIG. 3 is a flow chart of a method of creating a game to be deployed on a mobile device in accordance with an embodiment;

FIG. 4 is a schematic screenshot of a graphical user interface showing a prompt provided upon launch, in accordance with an embodiment;

FIG. 5 is a schematic screenshot of a graphical user interface showing a screen for selecting a game level in accordance with an embodiment;

FIG. 6 is a schematic screenshot of a graphical user interface showing a first default game level creation screen (or splash screen), in accordance with an embodiment;

FIG. 7 is a schematic screenshot of a graphical user interface showing a game level creation screen (or Backdrop), in accordance with an embodiment;

FIG. 8 is a schematic screenshot of the game level creation screen (or Backdrop) of FIG. 7, in a landscape mode and with game elements inserted therein, in accordance with an embodiment;

FIG. 9 is a schematic screenshot of the game level creation screen (or Backdrop) of FIG. 8, with collision rules defined therein as painted areas, in accordance with an embodiment;

FIG. 10 is a flow chart of a method of creating a new game element and defining parameters of an instance of the new game element, in accordance with an embodiment;

FIG. 11 is a schematic screenshot of a graphical user interface showing a game element drop down menu in accordance with an embodiment;

FIG. 12 is a schematic screenshot of a graphical user interface showing an actor edit drop down menu in accordance with an embodiment;

FIG. 13 is a schematic screenshot of a graphical user interface showing an actor definition drop down list associated with an enemy instance of an actor, in accordance with an embodiment;

FIG. 14 is a schematic screenshot of a graphical user interface showing another actor definition drop down list associated with a player instance of an actor, in accordance with an embodiment;

FIG. 15 is a schematic screenshot of the game level creation screen (or Backdrop) of FIG. 9, with a player icon and fire icons, in accordance with an embodiment;

FIG. 16 is a schematic screenshot of the game level creation screen (or Backdrop) of FIG. 15, with an enemy icon, in accordance with an embodiment; and

FIG. 17 is a flow chart of a method for managing a library of games on a hand held mobile processing device in accordance with an embodiment.

### DETAILED DESCRIPTION

The herein described game prototyping tool allows to quickly mock-up, test and deploy game mechanics to a mobile device such as an iPhone™ or an iPod™ Touch, or a Nexus One™, for example. The tool is adapted to perform a method as further described below. In other embodiments, the tool takes the form of a software application or any instructional signal allowing the implementation of the method. Yet again, the tool may take the form of a system or a computer readable media storing instructions to implement the method. The tool described herein is adaptable for use with any type of computer or mobile processing platforms such as the MAC™, PC™, iPhone™, iPod™, etc. A common coding base allows the tool to be deployed over a network of processing devices of various types, thereby permitting the formation of a community for the sharing or trading of games and game content, as will be further detailed.

One goal addressed herein is to remove barriers between game players and game developers by allowing the basic mechanisms of a game to be rapidly and easily tested. All forms of coding and programming typically necessary in game developing are removed. Non-programmers or coding-illiterate users can thus use the tool described herein to develop their own game: define game elements such as actors, enemies, game levels, props, triggers, weapons, collision volumes and other game content, rules associated with each one of the game elements such as how they interact with the game environment, how they move, etc., all without a single trace of coding.

Once a game prototype is generated, it may be directly sent to a mobile device, in a format which is compatible with the mobile device. In this way, the game prototype is directly deployable to any mobile device, for being played thereon. Alternatively or in addition to, the game prototype may be sent to another game development tool usable to further edit the game using coding for example, before optionally being returned back and re-formatted to be compatible with the mobile device. In addition, the game prototype may be sent to a custom application on the mobile device which acts as a library, and a hub in which the game is played, allowing dozens of games to be collected on the phone as well as traded with other phones and computers.

It is noted that the games may be created in any number of dimensions, though typically in two dimensions.

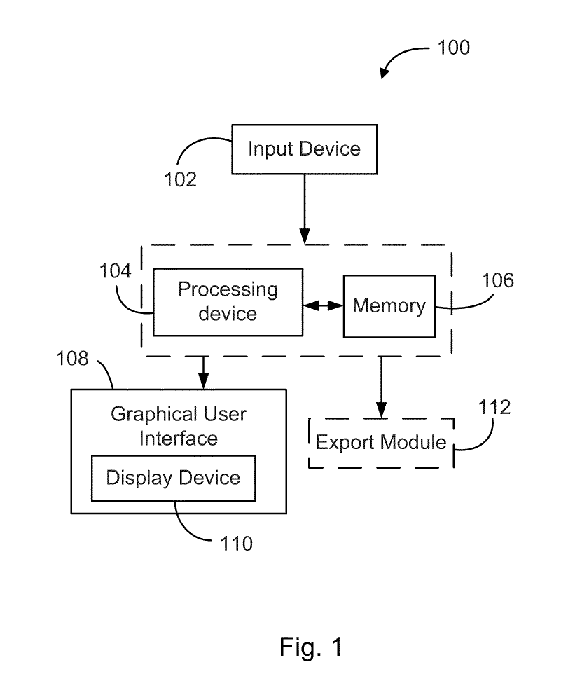

Now referring to FIG. 1, there is shown a system 100 for creating a game to be played on a mobile device, in accordance with an embodiment. The system 100 takes the form of a processing device such, conventional or mobile; such as: any type of personal computer, a cell phone device, a handheld or pocket-size computing device with a display screen, a personal digital assistance with a touch-screen interface, or a smart phone. In a case where the system 100 is implemented as part of a mobile device, the system 100 is also adapted for deploying the game thereon (i.e., for playing the game with the mobile device), or onto any other processing device for that matter.

The system 100 has an input device 102, a processing device 104 and a memory 106; a graphical user interface (GUI) 108 and a display device 110; and an import/export module 112.

The GUI 108 is adapted to display a substantially all-visual, programming-free computer environment on the display device 110, which can be any type of display (e.g., touch-screen, etc.). According to an embodiment, the programming-free computer environment may accept some input which is not all-visual; e.g., some words can be entered using a keyboard. The environment allows for interaction with a user, to establish at least one game level, one or more instances of at least one game element, and one or more game rules each applicable to either one of the instances, game elements and game levels.

The processing device 104 communicates with the graphical user interface 108 and the memory 106 to retrieve instructions stored in the memory 106 and receive interaction data from the GUI 108. The interaction data is indicative of the game levels, instances, game elements, game rules, or any other user input such as the name of a game, parameters of game elements, etc., which are to form part of the game.

The processing device 104 implements the instructions stored and retrieved from the memory 106 to create a game file based on the interaction data. The game file comprises all the elements, their instances, the game levels and rules, with their respective parameters as set by the user.

The memory 106 optionally comprises instructions for implementing the processing device 104 to receive a game editing command from the GUI 108 upon the user interacting with the computer environment; and then to update the game file in accordance with the game editing command.

Once the game file is created, optionally edited/updated, and the game is finalized as per the user's likings, the processing device 104 generates a game prototype from the final game file, as per the instructions stored in memory 106. The game prototype and the game file are storable in the memory 106 at any point in time.

The processing device 104 then communicates the game prototype to the GUI 108 in order to display the game prototype in the computer environment. This provides a visual mock-up of the game for the user to see the game as, or similarly as, it is to be seen once deployed and played on the mobile device; all before the game prototype is to be formatted into a fully publishable game. For example, a mock-up display shows the game levels and the instances of the game elements in accordance with the game rule(s). The user may decide at any point to again edit the game element(s), level(s) and rule(s), upon which the game file is updated and the game prototype is re-generate or updated accordingly in the processing device 104.

The processing device 104 then formats the game prototype into a formatted game, which is made of coding understandable by the mobile processing device on which the game is to be deployed or by a custom application designed to run it on the mobile platform. Once the formatted game is transferred to the mobile device via the import/export module 112 (and, possibly, an export icon on a user interface) and any type of connection or network (cable or wireless), the corresponding game is deployed and displayed on the mobile device so as to be playable thereon.

Still referring to FIG. 1, further to exporting the formatted game, the import/export module 112 is adapted to export any game content stored for example into memory 106, to any other processing device (not shown); mobile or conventional computing device. The import/export module 112 is also optionally adapted to receive other games, game prototypes, and/or game content from other processing devices (not shown), over a wireless network or a wired connection. Image and sound data files can also be imported by the import/export module 112, for use by the system 100 when creating the game. For example, user-generated graphics of all kinds can be imported and used as part of the game's background and/or to create game elements of all types. Such image data can correspond to a picture taken using any mobile device such as the cell phone with which the game is being created.

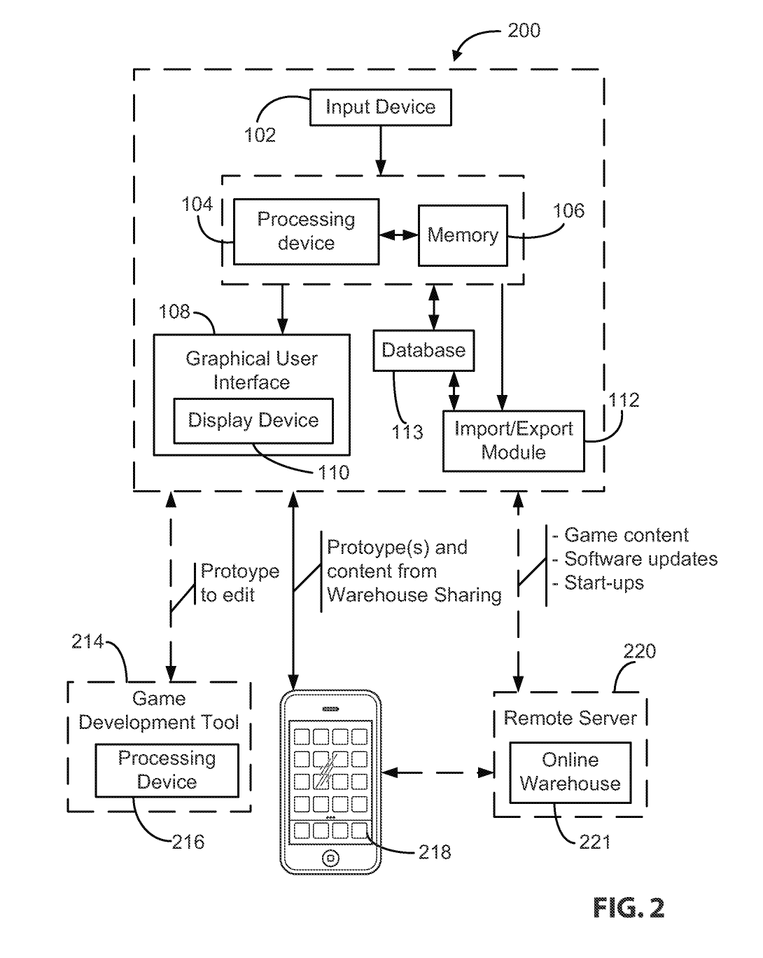

Now referring to FIG. 2, there is shown a system 200 similar to the system 100 of FIG. 1, in use with other processing devices such as: a game development tool 214 and processing device 216, a mobile device 218; and a remote server 220.

In one embodiment, the processing device 216 of the game development tool 214 is adapted with software usable to further edit the game, and/or game prototype exported thereon. For example, the import/export module 112 is adapted to output an XCode file corresponding to the game prototype; the XCode file is usable by the game development tool 214 to further test and edit the game using programming. Once edited, the game and/or game prototype may be returned to the system 200, again via, the import/export module 112. In a non-illustrated alternative, the edited game is adapted for mobile phones as per the prior art, and made available for users for download onto their mobile devices, via an online server for example. The game development tool 214 can be any type of professional game development software usable to deploy a full version of a game onto a mobile or other processing device, for example.

The mobile device 218 can be any type of mobile device with which it is possible to deploy a game; and optionally to create and edit games similarly to system 100 (FIG. 1) and 200. In one embodiment, the mobile device 218 is adapted to itself communicate with another processing device such as the game development tool, the remote server 220 and/or another mobile device (not shown) or the system 200.

Still referring to FIG. 2, the system 200 has a database 113 for storing games, game prototypes, games files and a warehouse of game content such as game elements, game rules and game levels. The import/export module 112 is adapted to export to any one of elements 216, 218 and 220, data stored in this database 113. In this way, game content stored in the warehouse database is sharable, individually or within categories of content, with other mobile users. Similarly, the import/export module 112 allows for the reception of game content pre-stored on another “warehouse” databases such as the online warehouse 221 remote from the processing device 104. The mobile device 218 also optionally has its own warehouse available for sharing with the system 200.

The online warehouse 221 stores collections of game contents such as game elements, game levels, instances of game elements, game rules, etc. which are ready-for-use to develop a game (i.e. they are coding-free elements, with already-defined graphics and/or parameters). This warehouse is accessible to the system 200 for allowing users to search its content and transfer selected content therefrom. The processing device and the GUI of system 200 is also adapted to display a sharing button to users such that, upon being selected, at least a portion of the content in the database 113 is uploaded to the online server 220 and stored in the online warehouse 221 for sharing or trading with other users accessing this database 221.

Both the online warehouse 221 and the database 113 optionally store game content such that these are retrievable in terms of their associated popularity of usage, creation date, or uploaded/downloaded date for example.

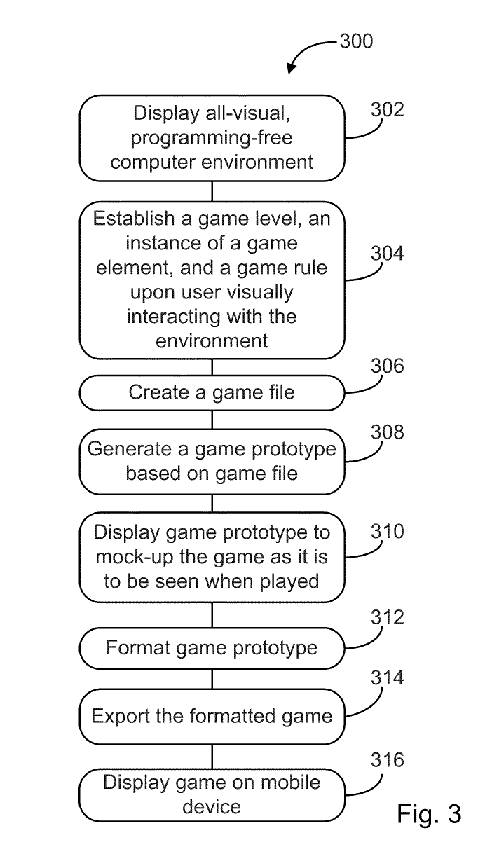

Now turning to FIG. 3, there is shown a flow chart of a method 300 of creating a game to be deployed on a mobile device. The method 300 comprises the following steps, which are implementable by any one of the above-described systems 100 and 200 of FIGS. 1 and 2 respectively. Alternatively, the method 300 is implemented via coding instructions stored on a computer readable storage media which, once run by a processing device, implement the processing device to perform the method 300.

In step 302, a substantially all-visual, programming-free computer environment is displayed to a user. A display unit in combination with a GUI can be used to display such an interactive environment.

In step 304, at least one game level, one or more game elements with associated one or more instances, as well as one or more game rules are established upon a user visually interacting with the environment. In one example, a user's input forms user interaction data which is indicative of the established game levels, elements, instances, and rules and other game data.

In step 306, a game file is created based on the user interaction data. The game file comprises the user established game elements, instances, rules and levels, with their respective parameters, and other relevant game data as the case may be.

In step 308, a game prototype is generated based on the game file.

In step 310, the game prototype is displayed to mock-up the game as it is to be seen when the game is to be deployed and played. In one embodiment, this step involves communicating the game prototype to a GUI for representation to a user on screen.

In step 312, the game prototype is formatted to be understandable by a mobile device onto which the game is to be played. The game prototype once formatted, is referred to as a formatted game.

In step 314, the formatted game is optionally exported to a mobile device or to another processing device of any type which supports the format of the formatted game.

In step 316, the formatted game is displayed on a mobile device for deployment and playing of the game thereon. The mobile device onto which the game is displayed can be a mobile device which also implements steps 302 to 312 and optional 314, or any other mobile device which received the formatted game at step 314.

In one case, optional step 314 is performed after step 316. In another case, step 314 is performed before and after step 316, as desired.

When step 314 is achieved to further edit the game (one formatted) and/or the game prototype, using another processing device, the game is exported to the other processing device after being formatted in step 312 to be compatible with the other processing device in question. In a specific example of this case, the formatting 312 involves transforming the game prototype into an XCode file which is readable by a game development tool for mobile gaming, as implemented by the other processing device. By game development tool for mobile gaming, it is intended to refer to software applications optionally associated with mobile devices, and used to develop games for mobile devices. An example of such a game development tool is the iPhone™ Game Development Tool.

Although not illustrated in FIG. 3, the method 300 allows for the editing of the game file upon the user editing previously established game data such as the game rules, elements, instances of elements and levels during the game development process. The method 300 thus allows another step or set of steps where a game editing command is received as provided by the user interacting with the computer environment; and where the game file is updated in accordance with the game editing command. In one embodiment, the editing command is generated in a user interface, and sent to be processed by the processing device implementing the method 300. Such editing can be considered as forming part of step 304 and 306, where the updating of a previously created game file takes place at step 306.

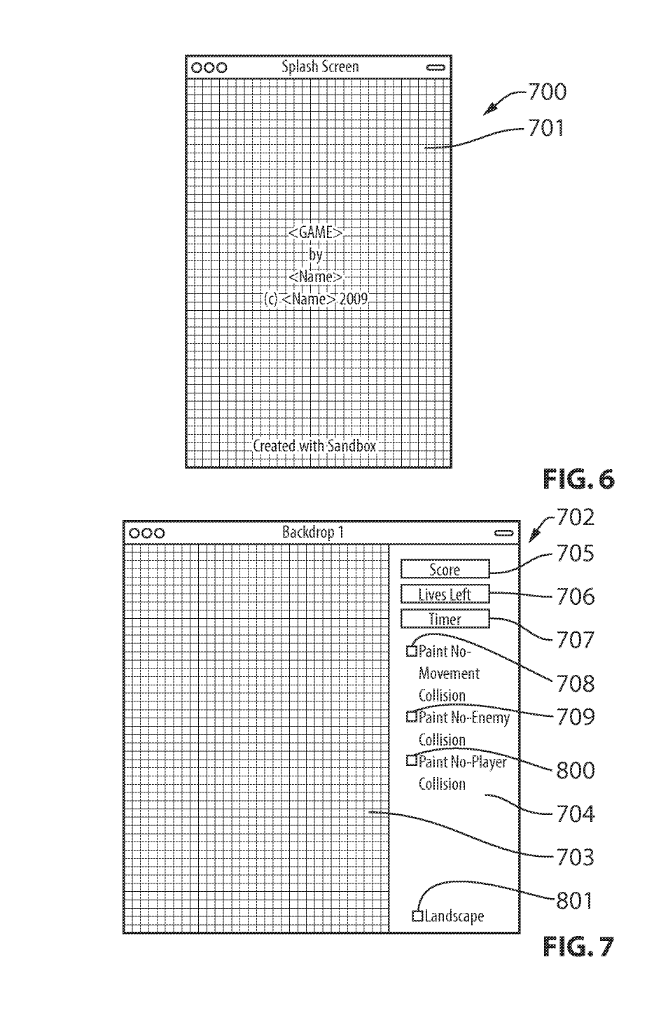

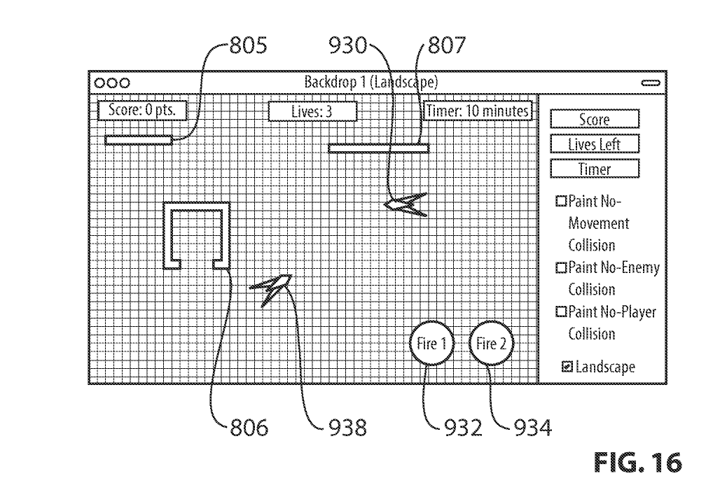

Still in reference to FIG. 3 and the method 300, in one example of step 310, once created, the game element(s) is displayed in the user environment in accordance with a hand-drawn-like appearance, as illustrated in FIGS. 15 and 16 which are described in greater detail below. Step 310 may also involve displaying a game level with a graphical paper-like background, as illustrated in FIGS. 6-9 and 15-16 which are also described in greater detail below.

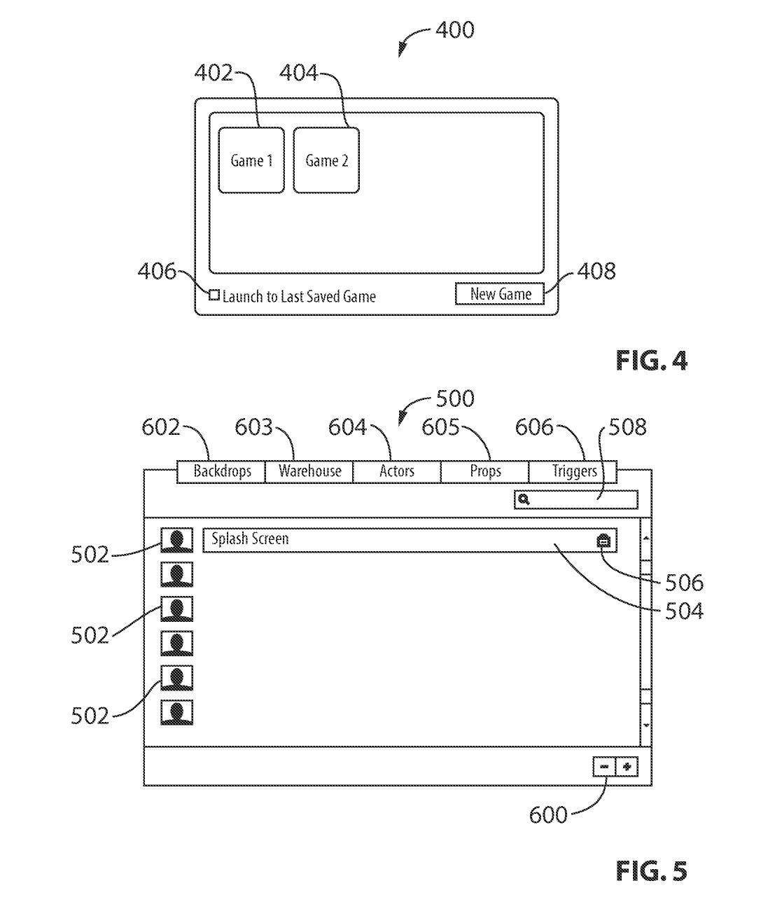

In one embodiment of step 302, game element icons corresponding to multiple available game elements are displayed to a user. The user is able to choose one of the available game elements by selecting an icon using an input device such as a mouse, a touch-screen or a voice command for example. In such a case, step 304 involves receiving interaction data indicative of the user selected icon, and then establishing an instance of the game element corresponding to the user selected icon and user entered parameters for the instance. To select the game element, the user is able to drag and drop the selected icon from the set of multiple icons, into the game level displayed. In an alternative or in addition, step 302 involves displaying a game element menu which provides a list of available types of game elements. Upon the user selecting one of the types in the menu, step 304 involves receiving the type selected and creating the game element in accordance to the type selected. Other menus can also be displayed to a user to allow various other game data selection, creation and definition in accordance with specific parameters, as described below with respect to FIGS. 4 to 16.

In addition to the above, the method 300 in FIG. 3 involves in some cases the storing of game elements in a game warehouse (also referred to as a game element database) described in greater detail below. The database is either locally accessible to the processing device implementing the method 300, or accessible via a communication network (i.e. wireless or cable). In either case, the game elements are retrieved from the database and displayed to the user for selection, editing, and incorporation into a game file.

In addition, method 300 involves, in some cases, the importing of image data files or sound data files, and the association of these imported files to a given game level and/or other game element. The game file is generated to incorporate these image files and sound files as per a user's preference(s). As stated above, any user-generated graphic is imported for use as part of the game's background and/or to create game elements of all types. Such image data can correspond to a picture taken using any mobile device such as the cell phone with which the game is being created.

A series of other steps are optionally provided as part of steps 302 and 304 of method 300. These will be further detailed in relation to FIGS. 4 to 16, which are screenshots of a graphical user interface. The GUI is fully visual and in plain language. In one example, every icon has a descriptive text (also referred to as a descriptor) pop-up to describe its meaning to a user.

FIG. 4 shows a prompt 400 displayed upon launching of the game development tool described herein. The prompt 400 allows the user to: select one of previously created game files respectively represented by game file icons 402 and 404; select that the last saved game file always opens upon launching by checking the selection box 406; or start a new game by creating a new game file by clicking a New Game icon 408.

FIG. 5 shows a game level selection menu screen 500 which enables the user to select one of several game levels previously established and saved in the currently opened game file. Each game level is represented by a game level icon 502, and has a user-entered level name 504 associated to it. A lock status 506 is also provided to indicate whether details of the game level are accessible for further edition. In one instance, the lock status 506 is modifiable only upon entering appropriate user identification. The game level at the top of the list is the first level in a game to be created, also referred to as a “Splash Screen”. Game levels in the list are sorted in accordance with an order in which they arrive in the game for example (i.e., established level hierarchy). Each level can be dragged and dropped at another location in the list to change the level hierarchy.

A search engine 508 is provided in one embodiment to enable users to run keyword searches through multiple previously created game levels. The −/+ icon 600 respectively allow, upon being selected, the deletion of a saved game level in the list and the initiation or addition of a new game level to the list.

As seen by the screenshot of FIG. 5, the game level selection menu screen 500 is one of multiple other menus displayed by the GUI, each menu is selectable via one of the tabs 602, 603, 604, 605 and 606. Selecting “Backdrops” tab 602 displays the game level selection menu 500. Similarly, selecting the “Warehouse” tab 603 provides a list of game content saved in the warehouse (i.e., a database of game elements, game rules, game levels and any other game objects which have been stored independently of the game file in which it was first created). Selecting the “Actors” tab 604 provides a list of all active game elements which are associated with the type “actor” (i.e., player or enemy for example). Selecting the “Props” tab 605 provides a list of all passive game elements which are associated with the type “props” (i.e. any object other than an actor which is to be present in the gaming environment of the game). Selecting the “Triggers” tab 606 provides a list of all game elements of the type “triggers” (i.e., a game action to be performed in association with a game level or another active or passive game element for example).

FIG. 6 shows a first game level creation screen 700 for a first default level (or “Splash Screen”), while FIG. 7 shows a game level creation screen 702 of a next game level, presented after the first level in the game when played. As seen in FIG. 6, the first level provides a user entered game name, author identity and date of creation. In the illustrated embodiment, the game name, author identity and date of creation as displayed in a frame area 701. Although not shown, an image data file can be inputted to the tool's memory, and used to provide an image background in the game frame area of screen 700, or in a game frame area of any other game level for that matter (as detailed hereinabove with reference to FIGS. 1 and 3).

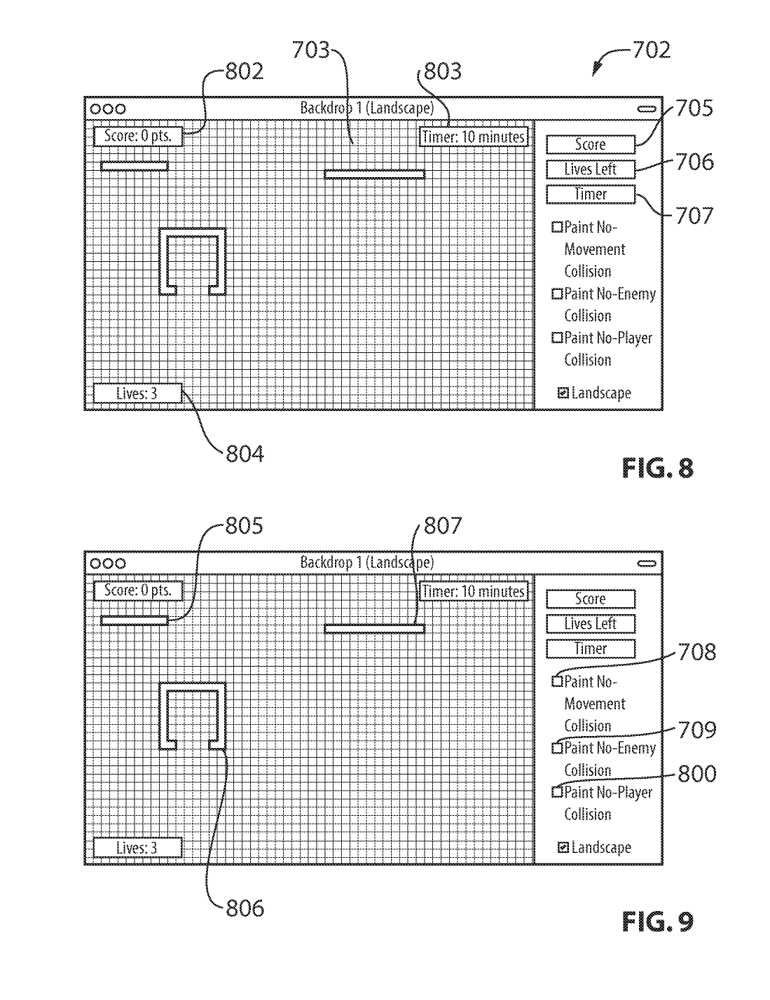

As seen in FIG. 7, the game level creation screen 702 presents a game frame area 703 for that level. A side panel 704 provides some game elements available for being inserted into the game frame area 703. These are represented by a “Score” icon 705, a “Lives Left” icon 706 and a “Timer” icon 707. Each of these icons respectively permit the insertion of a score indicator, a number of “lives left” indicator (e.g. in relation to a player for example), and a timer indicator. A user simply selects one of the icons 705, 706 and 707, and drags and drops it to a place in the game frame area 703. FIG. 8 illustrates the screen 702 once a score indicator 802, a timer indicator 803, and a number of “Lives Left” indicators 804 have been inserted into the game frame area 703.

Still in reference to FIG. 7, other icons 708, 709 and 800 represent available game rules. By clicking on one of the game rule icons 708, 709 and 800, a user is able to paint an area in the game frame area 703, as illustrated in FIG. 9. Depending on the specific icon 708, 709 or 800 selected, each one of painted areas 805, 806 and 807 is associated with one game rule which corresponds to the selected icon (e.g. 708, 709 or 800). Different colours are provided to differentiate the painted areas in terms of their respective game rule. More specifically, the painted areas 805, 806 and 807 in FIG. 9 each represent a location in the game where a given game rule is to be implemented. In the illustrated example, the game rules correspond to one of three collision rules, namely, a no-movement collision rule, a no-enemy collision rule; and a no-player collision rule. Other types of collision rules can also be created.

A non-exhaustive list of ways a user may add and define game elements and rules associated with an established game level, is provided below with their respective meaning in a game.

By right-clicking with a pointing device located on the displayed game frame area 703, a user may:

1) Insert any one of the following Paint collisions:

No Player: This prevents the player instance of an actor element from moving into the painted area where this rule is applicable.

No Enemy: This prevents all enemy instances from moving into the painted area where this rule is applicable.

No Movement: This prevents all game elements from moving into the painted area where this rule is applicable.

Path: A painted area shows a path that an Actor element (i.e., a player or an enemy) will follow when the game is played.

2) Insert a prop:

A user can drag and drop a prop stored in a warehouse database from a warehouse display window having icons for each stored element in the warehouse, into the game frame 703. If the warehouse display window is not yet opened, selecting to insert a new prop opens the warehouse window automatically. If there are no props saved in the warehouse, this option can be let unavailable.

3) Insert an Actor:

Similarly as inserting props, actor elements can be dragged and dropped from the warehouse display window to any one of pre-established game levels. The level at which the actor is inserted defines the actor's initial “spawn” position in the game (i.e. where and when they first appear in the game). Again, if the Warehouse display window is not open, this opens the Warehouse. If there are no Actors defined and stored in the warehouse, this option can remain unavailable to the user.

4) Insert a Trigger:

This can be done by the user selecting a portion of the game frame and right selecting “Trigger” for example. Another Trigger definition window appears to allow the user to define parameters of the trigger in the same way any other elements are defined. Alternatively, is a level is not open and a user select the creation of a new trigger, a lastly selected level opens automatically. This option remains unavailable if there is no pre-established game level.

Still in reference to FIGS. 7 to 9, marking the landscape option check box 801 transforms the game level creation screen 702 into a landscape presentation mode, as seen in FIGS. 8 and 9.

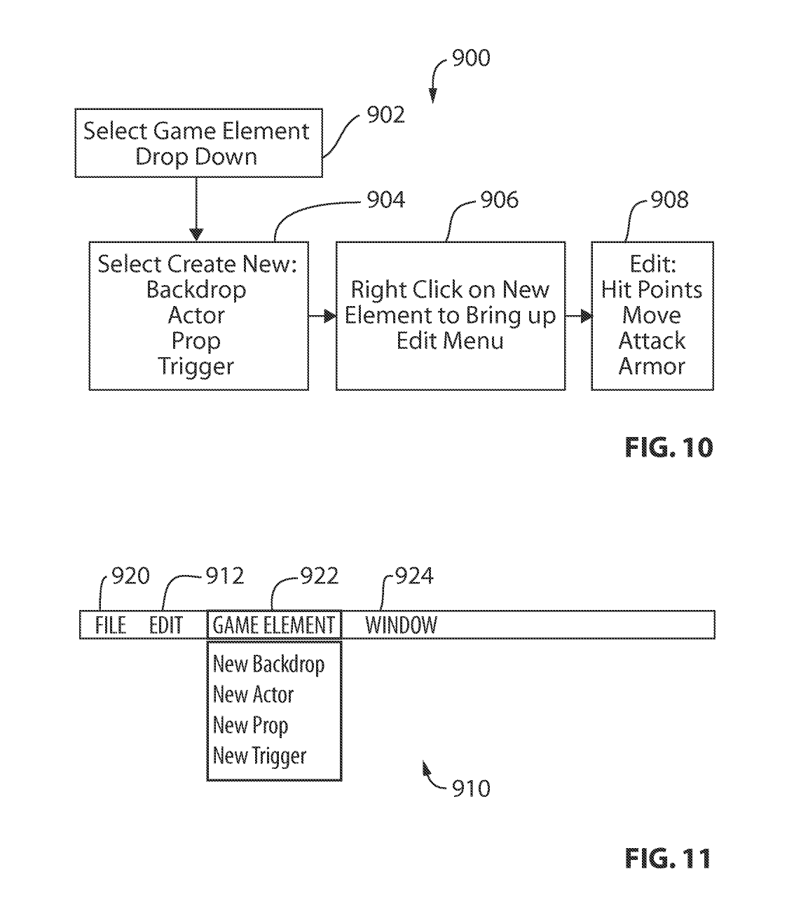

Now turning to FIG. 10, there is shown a flow chart 900 of steps to be followed by a user to create a new game element and define parameters to be associated with an instance of that element.

In step 902, the game element drop down menu is selected. In step 904, the “create new” tab of the drop down menu is selected, which presents a list of game elements to be created: a game level (backdrop); an actor (active game element); a prop (passive game element) and a trigger (action game element). In one embodiment, the list of such game elements is as shown in the game element tab 912 or the tool bar 910 of FIG. 11.

In step 906, right clicking on one of the game elements in the list of game elements to be created, calls the display of an Edit menu. The Edit menu presents a list of parameters to be associated with the game element being created. In step 908, the user may select and edit any one of the parameters in the list.

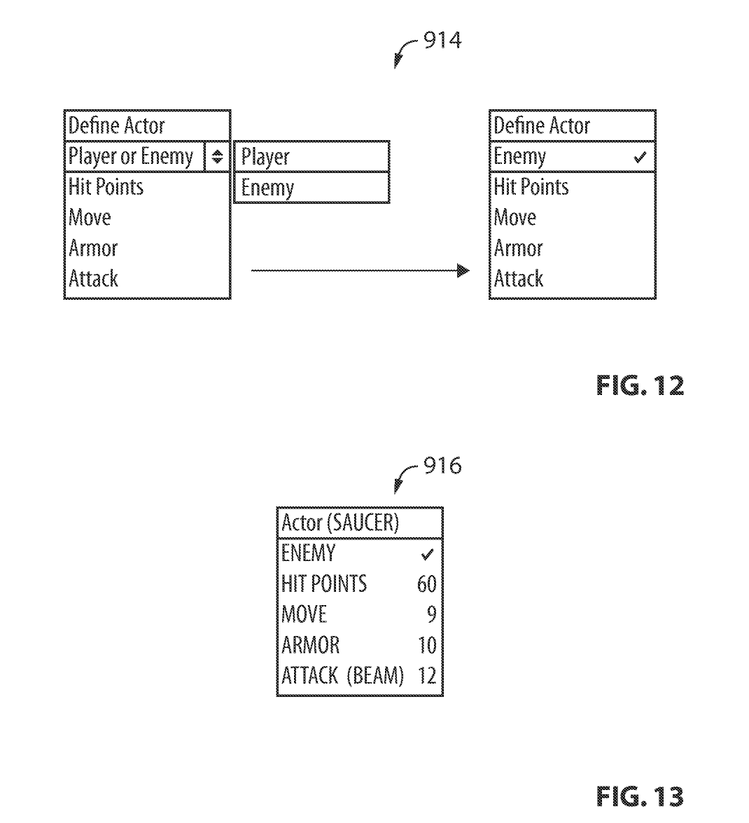

As an example, FIG. 12 shows the creation of an active game element (also referred to as an actor) using an actor edit drop down menu 914. The user first selects the active game element as being either one of an Enemy or a Player. The parameters associated with an active game element include: a number of hit points, a move, an attack, and an armour, which may all be edited.

The following provides a specific example of how an actor element can be defined by a user:

Once an active element is inserted on a game frame, right-clicking the actor element provides the following options available to define the parameters associated with an instance of an actor game element:

The actor is defined as an “enemy” instance of a “player” instance (of which there is generally only one in a game) by selecting one heading or the other to lock in the selection, which is later visible by a check mark beside the selection in the right-click menu of that instance.

When an actor is defined as a player instance, the user selects one of available input types to characterize the type of input device that is to be used on the mobile phone for controlling the player in the game. Once an input type is selected a sensitivity level of the input type is entered by the user to provide an indication of how sensitive the controls are going to be. The following provides a non-exhaustive list of input types:

Virtual D-Pad: The Player Actor is controlled by a virtual D-Pad in the corner of the screen.

Tilt: The Player Actor is controlled by an accelerometer for example, which is typically available on mobiles such as the iPhone™.

Drag and Follow: The Player Actor is controlled by dragging a path (appearing as a dotted line) which the Player Actor then follows.

Click and Follow: A playing user taps a location on the screen and the Player Actor moves towards it.

Hit points can also be defined for any type of actor to indicate how much damage the Actor can take before dying. Regeneration of hit points is specified to define a rate at which the Hit Points are regenerated for an Actor. A grade of 1 to 10 is optionally provided, whereby each grade level indicates a percentage of the total Hit Points regained. A single number value (Frequency) can be entered to indicate how often such Regeneration is allowed to occur in the game.

To define an attack power available to an Actor, a user enters three values for example: an Attack Damage (how much an attack by the actor inflicts on other actors); an Attack Speed (how quickly the attack can be used by the actor); and an Attack Range (how far the attack can go). Attack Damage is the amount of Hit Points the attack removes from a struck target. Players and enemies can have a limited type of attacks defined for them; two for example.

Each Attack defined for a Player instance is associated to a virtual attack button on the screen to provide a control of the attack to playing users. Such buttons are labelled by a name of each attack defines, such as “Attack 1” and “Attack 2”. These elements can be dragged around the edge of the screen to change a location where the button is to be available to the playing user.

Several types of attacks are listed below as examples:

Projectile: This attack hurls an object towards a selected target. Whatever this Projectile strikes suffers the damage.

Sweep: This attack draws a line from the shooter to the target, hitting anything in between. Setting a Sweep attack Range to a small value like 1 grid is an effective way to simulate a Melee Attack. Making it longer range defines it as a beam attack.

Each actor can have an armour defined. An armour is defined by a value which indicates how much damage inflicting the Actor is capable of getting through their armour and actually hitting the actor. It is a value which may be measured according to grades, such as from 0 (No Armour) to 10 (a Tank).

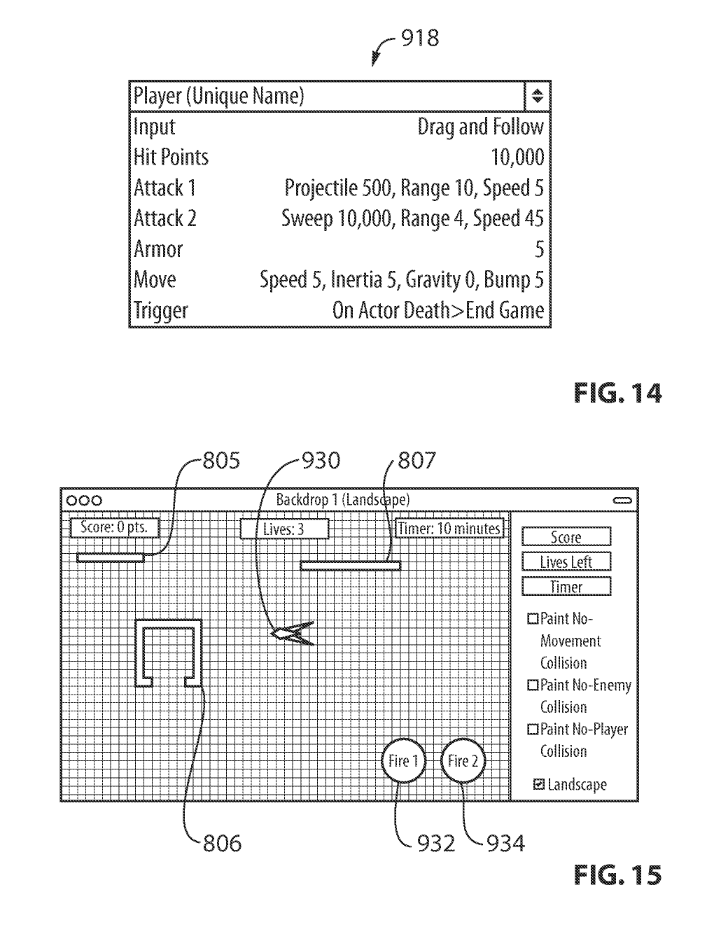

FIG. 13 shows an actor parameter drop down list 916 associated with an enemy instance of an actor, while FIG. 14 shows another actor definition drop down list 918 this time associated with a player instance.

Referring back to FIG. 11, other tabs are provided for being selected by the user, namely: a File tab 920 which allows a series of actions to be taken with respect to the game file; an Edit tab 922 which allows for the editing of the game file; the Game element tab 912 which, as detailed above in accordance with one embodiment, allows the creation of new game elements; and a “Window” tab 924 which provides for a customization of various display preferences for example.

The following provides functionalities which can be provided by selecting each one of the tabs 920, 922, 912 and 924:

1) Tab 920: File

New Game: This creates a new game. This will prompt a name for the Game from the user.

Open Recent Game: This is a drop down menu that shows previously saved Games. If there are none, this option is greyed out.

Close Game: This closes the current open Game.

Save Game: This saves the current Game project under the initial name given to it when it was created or last saved.

Save Game As: This redefines the Game, saving it under a new name.

Revert To Saved Game: This reverts the Game back to its last save state.

Deploy Game to mobile: This exports and deploys the game to the mobile.

2) Tab 922: Edit

Undo: This undoes the last editing action.

Redo: This redoes the last editing action.

Copy Game Element: This copies the selected Game Element to the clipboard.

Paste Game Element: This pastes the copied Game Element to the open Level. If there is no open Level, this option is greyed out.

Duplicate Game Element: This duplicates the selected Game Element on the open Level. The duplicate appears above and to the right of the duplicated game element.

Select All Game Elements: This selects all Game Elements in the current Level.

Deselect All Game Elements: This deselects all Game Elements in the current Level.

3) Tab 912: Game Element

New Level: This creates a new, blank Level.

New Actor: This creates a new, undefined Actor on the current Level. If no Level is open, this option is greyed out.

New Prop: This creates a new, undefined Prop on the current Level. If no Level is open, this option is greyed out.

New Trigger: This creates a new, undefined Trigger on the Level. If no Level is open, this option is greyed out.

4) Tab 924: Window

Select Current Level: This brings the current open Level to the front. If no Level is open, it selects the main Level from the Level list and opens it.

Level Select Screen: This brings up the Level Select Screen, which shows all available Levels by name. Double clicking on one opens it.

In addition to the above described tabs, a Warehouse tab is provided by the GUI in one embodiment (not shown in FIG. 11). The Warehouse tab opens the warehouse display window with icons for each game element like props and actors are stored.

Although also not illustrated in the Figures, a Tool Box floating menu is provided by the GUI, with graphical shortcuts to access a number of the functionalities. For example, a graphical shortcut for creating a new level, a new actor, a new prop, a new trigger, etc.

A selection screen is also provided by the GUI to define other parameters associated with game elements being established. For example, a way an actor moves is defined by entering a number which is reflective of a distance on the game frame 703 an actor moves per second when the game is played. An actor's inertia while moving can also be defined. A grading system can also be used to define how much inertia the Actor retains in movement; such as ranging from 0 (no inertia) to 10 (the actor will keep moving for a relatively long time in the game until it pushes in the opposite direction or bumps into something). Gravity can also be used to define how much gravity a game element such as another actor, a prop or a direction on the game level, exhibits Gravity on the Actor. If a grading scheme is used, 0 may define no gravity, while 10 will makes the actor be constantly drawn by the game elements in the game. Bumping action by the actor can also be defined. For example, a 0 grade can indicate that the actor never Bumps (i.e. other game elements pass through the actor), while 10 indicates that the Actor rebounds in the opposite direction at half the speed of the incoming other game element's speed. Other definition can be used. A Hit Points value of damage inflicted on those bumping the Actor can be entered, and vice versa.

Now referring to FIG. 15 there is illustrated the game level creation screen 702 (or Backdrop) of FIG. 9, with a player icon 930 corresponding to a player instance of an active game element. The player icon 930 is represented here by a hand-drawn bug-shaped character. FIG. 15 also has fire attack buttons 932 and 934. Both the player icon 930 and the fire attack buttons 932, 934 are displayed to act as per previously user entered parameters associated with each element. In FIG. 16, an enemy icon 938 is added. In the illustrated embodiment, the enemy icon 938 corresponds to an enemy instance of the active game element also used to create the player instance displayed as player icon 930. Different colours are used to visually differentiate the enemy instance from the player instance.

There will now be described one embodiment of the tool whereby a trigger is created and defined. It is noted that a Trigger can be a standalone Game Element on a game Level (referred to as an Independent Trigger), or be associated to a particular Actor (referred to as an Actor Trigger).

An Independent Trigger can be created and placed on a game level as a game element in and of itself. One example of an independent trigger is a “spawn point”. Once one or more Enemy instances are created, they can be dragged and dropped in the graphical user interface (GUI), onto an icon representative of the Independent Trigger placed on the game Level; this action transforms the Trigger into a “Spawn Point”. A “Spawn Point” defines a start position and a control of a number of Enemies which are to appear at the spawn point position, and when they appear in the game.

Modifying an independent trigger such as a “Spawn Point” is achievable by interacting with the GUI. For example, by right clicking when a pointer is over a spawn point brings up a window to edit parameters such as a “frequency of spawn” which defines how quickly enemies (for example) are to appear at this potion in time. A grading can be used: from 0 (No Respawn) to 10 (Spawn once per second). A Detection Radius can also be set which defines how the spawning of the spawn point is to be triggered during the game; for example: from 0 (Touch) to 10 (Any movement on the Level). A total number of spawned game items (also referred to as “Total Spawn”) can also be edited to establish how many items such as enemies in total are to appear from this spawn point upon being triggered.

In one embodiment, once an Actor element is defined as described hereinabove, the GUI presents a Trigger and an AI (Artificial Intelligence) menu to a user, allowing further definition. Triggers connected to Actors require some force to act upon the Actor before they trigger (or are activated). The Trigger menu provides a number of available types of Actor Triggers, such as: On Actor Death, On Actor Injury and On Actor Touch. Each type of trigger (Independent of Actor) can be defined by a unique Trigger set. Examples of Actor Triggers are provided below with respective definitions:

1) On Actor Death: When this particular Actor is killed (hits 0 Hit Points or less), one of several things can be set to occur. They are listed below:

On Actor Death: Add Points: A point value can be added to the Player's Point Total (see GUI for more details). In other words, blow up a particular ship, gain 600 points.

On Actor Death: Next Level: The game can move on to the next Level in the Level list. This is effectively “advancing” a level. You can have any number of levels. You will be prompted to place the player Actors' spawn point on the new level before this option is ready.

On Actor Death: End Game: The game ends, and goes to the GAME OVER screen, and then back to the Attract Screen.

On Actor Death: Spawn”: Selecting this allows you to place any number of previously established Enemies on the screen to spawn on the death of the Actor with the Trigger attached to them. For example, blow up the Mother Ship and a dozen smaller ships appear and attack. On Actor Injury: As above, except that the Actor suffers up to an amount of Hit Points damage. When they suffer over that amount, the Trigger event happens.

2) On Actor Touch: When the Actor touches another defined Actor or Game Element (or vice versa), one of several events can be set to occur, similarly to the events listed above for the “On Actor Death” trigger. An “On Actor Touch: Despawn” event can also be set to occur. Selecting this option allows the removal of any number of previously established Enemies to “despawn” upon the Actor being touched during play. By “despawn”, one refers to the disappearing of a game element such as an enemy. For example, such an event can be set to make Hunter Drones vanish when a player enters a safety field during play.

The AI Menu:

Once an Enemy Actor is defined, the AI and Trigger selections appear, allowing further customization. AI is used to allow the enemies to “act” without input from a player. Several types of AI can be selected for an enemy element. Some examples are detailed below:

Kill Target List (Proximity): The Enemy attacks a list of Game Elements within a particular range (listed in the number of Grid boxes it can “see”). You could, for example list Magic Crystal, Player, Saucer—meaning it would attack any of the following in range in that order. To have it only attack the Player, only put the Player on the list.

Random Patrol/Kill (Proximity): As above, but the Enemy randomly patrols.

Path/Kill (Proximity): As above, but the Enemy follows a set Path defined on the Level.

Linked: The AI is linked to another Enemy; selected from a drop down list. Linked Enemies always act together, and if possible, perform the same action. If the Linked Enemy is not in range when activated it will move at full speed to the target to engage it.

In a specific implementation of the above-described game deployment tool for mobile devices, two complementary applications are provided, one targeted for standalone processing devices such as personal computers, and another targeted for mobile devices. The first application provides for the creation editing and local testing and deployment of the games on the standalone computer, while the latter application provides for the reception of games from the first tool, the deployment of the games, playback and then sharing/trading of games with other processing devices, mobile or not. Both applications are made of a common language codebase for loading, saving, simulating and rendering of games prior to deployment. The loading and saving code is abstracted to interface with the different file access methods of different processing platforms and operating systems (i.e. PC™, Mac™ and iPhone™ for example), as well as being able to interface directly with various network transfer protocols. The simulation code is internally identical across both applications.

In one embodiment, the games are rendered using OpenGL™, which allows nearly identical code across all platforms, with the major differences rooted in window and frame buffer management. To allow cross-platform development on both PCs and Macs processing platforms for example, the front-end graphical user interface of the first application is based on a widget toolkit such as commonly known wxWidgets™ GUI framework. An example of the interface for the second application targeted to mobile devices such as the iPhone™ and the iPod Touch™, is the standard Cocoa Touch interface libraries provided as part of the iPhone™ SDK.

Still in accordance with a specific example, the deployment of games occurs over local networks, via the mobile devices' respective wireless (WiFi) connections. The above applications advertise themselves using what is commonly referred to as the ‘Bonjour network discovery service’, which allows for a simple enumeration and selection of devices available for deploying games thereon. A transfer protocol such as the TCP/IP protocol is used to perform the actual transfer of the games form one device to another. To provide for faster transfer of games over the network, in addition to being stored in the XML text-based format for example, they are stored in an alternate binary chunk-based format.

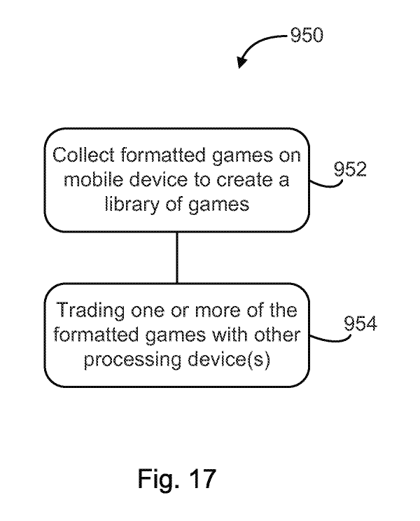

Finally in reference to FIG. 17, there is shown a flow chart of a method 950 for managing a library of games on a hand held mobile processing device in accordance with one embodiment.

In the first step 952, formatted games are collected on the hand held mobile processing device to create the library of games thereon. The library can be stored on a memory of the mobile device for example. Each of the formatted games in the library of games comprise coding which is understandable by the handheld mobile processing device to deploy at least one of the games being managed thereon.

In step 954, one or more of the formatted games in the library are traded between the mobile device and multiple other computers and/or other hand held mobile processing devices.

In one embodiment, the method 950 is provided by a custom application stored on a memory of a handheld mobile processing device to implement the steps 952 and 954. The custom application provides for the managing of the library of games on the handheld mobile processing device by implementing a link to the collection of formatted games constituting the library of games. The application also implements an import/export module one the handheld mobile processing device, for trading any one of the formatted games in the library of games with multiple computers and/or other hand held mobile processing devices.

While preferred embodiments have been described above and illustrated in the accompanying drawings, it will be evident to those skilled in the art that modifications may be made therein without departing from the essence of this disclosure. Such modifications are considered as possible variants comprised in the scope of the disclosure.

1. A method of creating a game to be deployed on a handheld mobile processing device, the method comprising:
displaying a visual, programming-free computer environment allowing a user to establish a game level, an instance of a game element, and a game rule applicable to at least one of the instance and the game level;
creating a game file comprising the game element, the instance of the game element, the game level, and the game rule;
generating a game prototype from the game file;
displaying the game prototype in the computer environment to provide a mock-up of the game as to be seen when the game is to be played, with the game level and the instance of the game element in accordance with the game rule; and
formatting the game prototype into a formatted game comprising coding understandable by the handheld mobile processing device to deploy the game.

2. The method of claim 1, further comprising exporting the formatted game to the handheld mobile processing device.

3. The method of claim 2, further comprising deploying the formatted game on the handheld mobile processing device using the coding.

4. The method of claim 3, further comprising displaying the game for playing on the handheld mobile processing device.

5. The method of claim 1, further comprising using a custom application on the hand held mobile processing device for at least one of:
collecting more than one formatted game on the hand held mobile processing device or on multiple computers;
displaying the formatted game on the hand held mobile processing device or on multiple computers; and
trading at least one of: the formatted game, the game prototype, the game level and the game element, with multiple computers or other hand held mobile processing devices.

6. The method of claim 1, further comprising exporting the formatted game to a processing device; and, in the processing device, further editing the game.

7. The method of claim 1, wherein the formatting the game prototype into the formatted game comprises: formatting the game prototype into an Xcode file; and exporting the Xcode file to an Xcode development tool associated with the handheld mobile processing device, for further editing of the game.

8. The method of claim 1, comprising receiving a game editing command provided by the user interacting with the computer environment; and updating the game file in accordance with the game editing command.

9. The method of claim 1, wherein the displaying the visual, programming-free computer environment comprises displaying game element icons corresponding to multiple available game elements; and receiving the instance of the game element upon the user dragging and dropping one of the game element icons into the game level.

10. The method of claim 1, wherein the displaying the visual, programming-free computer environment comprises displaying game element types in a game element menu; receiving a type of the game element upon the user selecting one of the game element types in the game element menu; and creating the game element in accordance with the type selected.

11. The method of claim 1, wherein the displaying the visual, programming-free computer environment comprises displaying available game rules in a game rule menu; receiving a user selection of one of the available game rules; and creating the game rule in accordance with the user selection.

12. The method of claim 1, comprising storing the game element in a game warehouse database accessible via a communication network.

13. The method of claim 1, comprising retrieving available game elements from a game warehouse database accessible via a communication network; and displaying the available game elements to the user.

14. The method of claim 1, comprising importing at least one of an image data file and a sound data file; and associating the at least one of the image data file and the sound data file to at least one of the game level and the game element; wherein the generating the game file comprises generating the game file based on the at least one of the image data file and the sound data file.

15. A system for creating a game to be deployed on a handheld mobile processing device, the system comprising:
a graphical user interface for displaying an visual, programming-free computer environment allowing a user to establish a game level, an instance of a game element, and a game rule applicable to at least one of the instance and the game level, via visual interaction with the computer environment;
a processing device in operative communication with the graphical user interface; and
a memory device operatively coupled to the processing device, the memory device comprising instructions for implementing the processing device to:
create a game file comprising the game element, the instance of the game element, the game level, and the game rule;
generate a game prototype from the game file;
display the game prototype in the computer environment to provide a mock-up of the game as to be seen when the game is to be played, with the game level and the instance of the game element in accordance with the game rule;
format the game prototype into a formatted game comprising coding understandable by the handheld mobile processing device; and
display the game on the handheld mobile processing device as provided by the coding of the formatted game, to allow the game to be deployed and played on the handheld mobile processing device.

16. The system of claim 15, comprising an export module for exporting the formatted game to at least one of the handheld mobile processing device, and an other processing device adapted to further edit the game.

17. The system of claim 16, wherein the export module is adapted to output an Xcode file from the game prototype, to an Xcode development tool associated with the handheld mobile processing device.

18. The system of claim 15, wherein the memory device comprises instructions for implementing the processing device to receive a game editing command from the graphical user interface upon the user interacting with the computer environment; and updating the game file in accordance with the game editing command.

19. A method for managing a library of games on a hand held mobile processing device using a custom application, the method comprising:
collecting formatted games on the hand held mobile processing device to create the library of games, each of the formatted games comprising coding understandable by the handheld mobile processing device to deploy at least one of the games; and
trading at least one of the formatted games with multiple computers or other hand held mobile processing devices.

20. A custom application for managing a library of games on a hand held mobile processing device, the custom application comprising:
a link to a collection of formatted games on the hand held mobile processing device which constitute the library of games, each of the formatted games comprising coding understandable by the handheld mobile processing device to deploy at least one of the games; and
an import/export module for trading at least one of the formatted games with multiple computers or other hand held mobile processing devices.
